(19) United States
(12) Patent Application Publication
(10) Pub. No.: US 2026/0148007 A1
(43) Pub. Date: May 28, 2026

(54) SYSTEM AND METHOD FOR ARTIFICIAL-INTELLIGENCE-BASED AUTOMATIC REVISION OF SENTENCES BASED ON READABILITY AND SENTIMENT ANALYSES

(71) Applicant: PwC Product Sales LLC, New York, NY (US)

(72) Inventors: Jihoon PARK, Herndon, VA (US); Khai Hoang LAI, San Francisco, CA (US); Joshua Anthony RIOS, Atlanta, GA (US); Abhishek SANGHAVI, Dallas, TX (US); Elizabeth Ann CREGO, New Providence, NJ (US); Michael James BELLIN, Fort Collins, CO (US); Joseph Doyle HARRINGTON, Granite Bay, CA (US); Nicholas Kyle KNISLEY, Cincinnati, OH (US); Jonathan Arthur RUCKER, Charlotte, NC (US)

(73) Assignee: PwC Product Sales LLC, New York, NY (US)

(21) Appl. No.: 18/962,750

(22) Filed: Nov. 27, 2024

(51) Int. Cl. G06F 40/30; G06F 40/166; G06F 40/197

(52) U.S. Cl. CPC G06F 40/30; G06F 40/166; G06F 40/197

(57) ABSTRACT

A system for automatically assessing sentiment and readability of sentences in one or more documents is disclosed. The system applies a sentiment mismatch analysis and generates sentence rewrites based thereon. The system applies readability analysis and generates sentence rewrites based thereon. The system generates combined sentence rewrites based on the readability rewrites and the sentiment rewrites, and generates an updated output document based thereon. In some embodiments, the system intercepts and automatically halts publication of documents pending analysis for satisfaction of readability and sentiment criteria. In some embodiments, the readability and sentiment analyses are configured in accordance with user inputs and/or with information regarding third-party AI analyses to which the documents are expected to be subjected following publication.

### FIELD

The present disclosure relates generally to systems and methods for rewriting the sentences in an input document for clearer sentiment and readability tailored to a particular subject matter and/or intended audience. More specifically, the present disclosure relates to systems and methods for generating sentiment sentence rewrites and readability sentence rewrites for one or more sentences in an input document.

### BACKGROUND

Organizations across all industries consistently publish public documents and distribute internal documents that convey important information about the current state and future plans of the organization, related organizations, or field of study or expertise. For example, a research organization might publish a report conveying statistical information and/or projections about a field of study. Or, an organization might publish a public report conveying key information about the recent performance of the organization, intending to convey the prospects for the organization. Or, an organization working in a certain technological field might publish a report conveying information about the current state of resources, resource utilization, resource production, and/or resource allocation in the technological field; for example, reports might convey information about supply, production, and allocation of scarce resources such as energy sources (e.g., fuel) or computational resources in distributed computing systems.

### SUMMARY

Given the importance of published documents describing statistical information, economic outlook information, resource information, or the like, these documents may have a significant impact on decision making for organizations, or for other persons or organizations related to the publishing organization. For this reason, organizations must strive to ensure that the documents are written clearly, accurately, and in the correct tone for the subject matter, information to be conveyed, and intended audience.

Conventionally, ensuring a document satisfies target criteria for readability and tone is addressed manually, by identifying and rewriting certain portions of a document that are subjectively deemed to be less than optimal. However, accurately identifying trouble sentences or other issues with readability and sentiment, and manually rewriting, is time-consuming and unreliable due to its subjective nature. Manual reviewers, even experts, may miss or create readability and sentiment issues throughout the document, requiring multiple rounds of revisions.

Furthermore, modern artificial-intelligence-based tools have enabled automated analysis of published documents. Using these AI tools, actions may be automatically triggered in response to the contents of document publication at unprecedented speed and scale. For example, AI tools may be configured and deployed to automatically scrape and analyze documents published by an organization, and to automatically trigger actions such as: automatic purchase or sale of assets, automatic shipment of goods, automatic instantiation or de-instantiation of electronic resources such as compute or storage resources, automatic operation state changes to energy production facilities, automatic operation state changes to agricultural equipment and facilities, automatic operation state changes to manufacturing equipment or other industrial equipment, automatic instantiation or de-instantiation of electronic communication channels, and/or automatic transmission of electronic communications. Because these actions can be triggered automatically at rapid speed and at massive scale in response to the content, readability, and/or sentiment of published documents, it is more important than ever for organizations to ensure that published documents include the desired content, readability, and sentiment, such that an organization can trigger automated events that are desired and avoid triggering those automated events that are not desired, even when those events are controlled by third-party AI systems.

Accordingly, there is a need for improved systems, methods, and techniques for automatically monitoring documents for potential publication, assessing the content (including readability and sentiment) of said documents, and taking automated action in response to the assessment of said content. The automated actions may include preventing publication of a document for which readability and/or sentiment criteria are not met, allowing publication of a document for which readability and/or sentiment criteria are met, automatically generating proposed modifications to a document for which readability and/or sentiment criteria are not met, and providing a graphical user interface for users to interactively modify a document for publication based on the generated proposed modifications. Disclosed herein are systems, methods, electronic devices, non-transitory storage media, and apparatuses that may address one or more of the above-identified needs.

In some embodiments, a system is provided that monitors documents for proposed publication, for example by receiving an uploaded document from a user for potential publication, and/or by monitoring for attempted publication of a document by a user and intercepting the attempted publication (e.g., by automatically blocking electronic transmission of the document pending assessment).

The system may apply one or more automated, AI-based analyses of the content of the proposed document, including by performing a readability assessment data processing operation and a sentiment analysis data processing operation. The system may automatically determine whether readability and/or sentiment criteria are met, which may be based on application of one or more AI models. Determination of whether criteria are met may also be based on one or more user inputs (e.g., executed via a graphical user interface) indicating what third-party AI models may be used to assess the published document. Based on the outcome of the assessment of whether readability and/or sentiment criteria are met, the system may automatically block publication of the document (if criteria are not met) or automatically allow publication of the document (if criteria are met).

In instances in which readability and/or sentiment criteria are not met, the system may apply one or more AI models to automatically generate proposed modifications, such as proposed rewrites of sentences, to the proposed document. As explained in further detail herein, the system may generate one set of proposed modifications and/or rewrites based on readability analysis, one set of proposed modifications and/or rewrites based on sentiment analysis, and combined proposed modifications and/or rewrites based on both the readability analysis and the sentiment analysis.

For example, the systems and methods described herein may identify trouble sentences by applying a sentiment mismatch analysis and/or a readability analysis to the document. The sentiment mismatch analysis may identify sentences with one or more word-sentence sentiment mismatches. The readability analysis may identify sentences with low readability scores and/or readability scores that do not match the intended audience. The systems and methods described herein may then select a number of example rewrites corresponding to the identified trouble sentences and a list of fixed terms related to the subject matter of the document. The systems and methods described herein may further generate rewrites for trouble sentences by providing them, along with the selected example rewrites alternatively with the list of fixed terms, to one or more machine learning and/or generative AI models.

The system may then automatically generate and store a revised/updated document based on one or more of the proposed modifications, and/or may display the proposed modifications to the user. In some embodiments, the proposed modifications may be displayed via a graphical user interface to the user. The proposed modifications may be displayed in an interactive manner such that the user can view the proposed modifications, drill down on one or more proposed modifications to see explainability information regarding the reason for the proposed modification, and accept, reject, or further modify one or more of the proposed modifications.

After optional user input via the graphical user interface, the system may automatically publish (or otherwise electronically transmit) the modified electronic document.

In some embodiments, a system for generating sentiment sentence rewrites and readability sentence rewrites for one or more sentences in an input document is provided, the system comprising memory storing instructions and one or more processors configured to execute the instructions to cause the system to: receive data representing the input document; identify a plurality of sentences in the input document and a plurality of words corresponding to each of the identified plurality of sentences; apply a sentiment mismatch data processing operation based on the identified plurality of sentences and the identified plurality of words to determine whether one or more word-sentence combinations with a sentiment mismatch are present; apply a readability data processing operation based on the identified plurality of sentences to determine whether one or more sentences of the identified plurality of sentences fails one or more readability criteria; in accordance with a determination that one or more word-sentence combinations with a sentiment mismatch are present and a determination that one or more sentences of the identified plurality of sentences do not fail one or more readability criteria, generate one or more first sentence rewrites for one or more sentences of the identified plurality of sentences containing the one or more word-sentence combinations with a sentiment mismatch, wherein the one or more first sentence rewrites are based on a plurality of sentiment mismatch rewrite examples; in accordance with a determination that one or more word-sentence combinations with a sentiment mismatch are not present and a determination that one or more sentences of the identified plurality of sentences fail one or more readability criteria, generate one or more second sentence rewrites for the one or more sentences that fail one or more readability criteria, wherein the one or more second sentence rewrites are based on a plurality of readability rewrite examples; in accordance with a determination that one or more word-sentence combinations with a sentiment mismatch are present and a determination that one or more sentences of the identified plurality of sentences do fail one or more readability criteria, generate one or more combined sentence rewrites for one or more sentences of the identified plurality of sentences containing the one or more word-sentence combinations with a sentiment mismatch and failing the one or more readability criteria, wherein the one or more combined sentence rewrites are based on the plurality of sentiment mismatch rewrite examples and the plurality of readability rewrite examples; store one or more generated rewrites from the set comprising: the one or more generated first sentence rewrites, the one or more generated second sentence rewrites, and the one or more generated combined sentence rewrites in memory; and generate and display a digital output document comprising one or more generated rewrites from the set comprising: the one or more generated first sentence rewrites, the one or more generated second sentence rewrites, and the one or more generated combined sentence rewrites.

In some embodiments, applying the sentiment mismatch data processing operation comprises: for each sentence of the identified plurality of sentences: determining a corresponding sentence sentiment; for each of the identified plurality of words in the corresponding sentence, determining a corresponding word sentiment; comparing the corresponding sentence sentiment to the corresponding word sentiments for each of the identified plurality of words in the corresponding sentence; and determining whether the one or more word-sentence combinations with a sentiment mismatch are present.

In some embodiments, generating the one or more first sentence rewrites comprises: receiving the plurality of sentiment mismatch rewrite examples; comparing the one or more sentences of the identified plurality of sentences containing the one or more word-sentence combinations with a sentiment mismatch with the plurality of sentiment mismatch rewrite examples; selecting, for each of the one or more sentences of the identified plurality of sentences containing the one or more word-sentence combinations with a sentiment mismatch, a predetermined number of corresponding sentiment mismatch rewrite examples from the plurality of sentiment mismatch rewrite examples; providing the one or more sentences of the identified plurality of sentences containing the one or more word-sentence combinations with a sentiment mismatch and the selected predetermined number of corresponding sentiment mismatch rewrite examples to a machine learning model; and receive, from the machine learning model, output data comprising the one or more first sentence rewrites.

In some embodiments, the selected corresponding sentiment mismatch rewrite examples are most similar to the corresponding sentence of the one or more sentences of the identified plurality of sentences containing the one or more word-sentence combinations with a sentiment mismatch.

In some embodiments, the corresponding sentiment mismatch rewrite examples are selected using semantic searching.

In some embodiments, the corresponding sentiment mismatch rewrite examples are selected by: generating embeddings for each of the one or more sentences of the identified plurality of sentences containing the one or more word-sentence combinations with a sentiment mismatch and each of the plurality of sentiment mismatch rewrite examples; and comparing the generated embeddings for each of the one or more sentences of the identified plurality of sentences containing the one or more word-sentence combinations with a sentiment mismatch with the generated embeddings for each of the plurality of sentiment mismatch rewrite examples.

In some embodiments, the one or more word-sentence combinations with a sentiment mismatch comprise only words corresponding to the sentence that are not in a predetermined word list.

In some embodiments, each sentiment mismatch rewrite example of the plurality of sentiment mismatch rewrite examples comprises: an initial version of the respective sentiment mismatch rewrite example containing one or more word-sentiment mismatches; and a rewritten version of the respective sentiment mismatch rewrite example containing fewer word-sentiment mismatches than the initial version.

In some embodiments, identifying the one or more word-sentence combinations with a sentiment mismatch comprises determining that one or more of the corresponding word sentiments are classified into a first classification and the corresponding sentence sentiment is not classified into the first classification.

In some embodiments, applying the readability data processing operation comprises: for each sentence of the plurality of identified sentences: determining a corresponding readability score; comparing the corresponding readability score with the one or more readability criteria; and determining that the corresponding readability score fails the one or more readability criteria by falling outside one or more readability criteria windows.

In some embodiments, determining the corresponding readability score is based on determining one or more of the following metrics: an average length of sentences in a document and a percentage of long words in a sentence or document.

In some embodiments, generating the one or more second sentence rewrites comprises: receiving the plurality of readability rewrite examples; comparing the one or more sentences that fail one or more readability criteria with the plurality of readability rewrite examples; selecting, for each of the one or more sentences that fail one or more readability criteria, a predetermined number of corresponding readability rewrite examples from the plurality of readability rewrite examples; providing the one or more sentences that fail one or more readability criteria and the selected predetermined number of corresponding readability rewrite examples to a machine learning model; and receive, from the machine learning model, output data comprising the one or more second sentence rewrites.

In some embodiments, the corresponding readability rewrite examples are most similar to the corresponding sentence of the one or more sentences that fail one or more readability criteria.

In some embodiments, the corresponding readability rewrite examples are selected using semantic searching.

In some embodiments, the corresponding readability rewrite examples are selected by: generating embeddings for each of the one or more sentences that fail one or more readability criteria and each of the plurality of readability rewrite examples; and comparing the generated embeddings for each of the one or more sentences that fail one or more readability criteria with the generated embeddings for each of the plurality of readability rewrite examples.

In some embodiments, each readability rewrite example of the plurality of readability rewrite examples comprises: an initial version of the respective readability rewrite example that fails at least one of the one or more readability criteria; and a rewritten version of the respective readability rewrite example that fails fewer of the one or more readability criteria than the initial version.

In some embodiments, the one or more readability criteria comprises at least one of a lower readability score threshold and an upper readability score threshold.

In some embodiments, generating the one or more combined sentence rewrites comprises: receiving the plurality of sentiment mismatch rewrite examples; receiving the plurality of readability rewrite examples; comparing the one or more sentences of the identified plurality of sentences containing the one or more word-sentence combinations with a sentiment mismatch and failing the one or more readability criteria with the plurality of sentiment mismatch rewrite examples and the plurality of readability rewrite examples; selecting, for each of the one or more sentences of the identified plurality of sentences containing the one or more word-sentence combinations with a sentiment mismatch and failing the one or more readability criteria, a predetermined number of corresponding sentiment mismatch rewrite examples from the plurality of sentiment mismatch rewrite examples and a predetermined number of corresponding readability rewrite examples from the plurality of readability rewrite examples; providing the one or more sentences of the identified plurality of sentences containing the one or more word-sentence combinations with a sentiment mismatch and failing the one or more readability criteria, the selected predetermined number of corresponding sentiment mismatch rewrite examples, and the selected predetermined number of corresponding readability rewrite examples to a machine learning model; and receive, from the machine learning model, output data comprising the one or more combined sentence rewrites.

In some embodiments, the corresponding sentiment mismatch rewrite examples and the corresponding readability rewrite examples are most similar to the corresponding sentence of the one or more sentences of the identified plurality of sentences containing the one or more word-sentence combinations with a sentiment mismatch and failing the one or more readability criteria.

In some embodiments, the corresponding sentiment mismatch rewrite examples and the corresponding readability rewrite examples are selected using semantic searching.

In some embodiments, the corresponding sentiment mismatch rewrite examples and the corresponding readability rewrite examples are selected by: generating embeddings for each of the one or more sentences of the identified plurality of sentences containing the one or more word-sentence combinations with a sentiment mismatch and failing the one or more readability criteria, each of the plurality of sentiment mismatch rewrite examples, and each of the readability rewrite examples; and comparing the generated embeddings for each of the one or more sentences of the identified plurality of sentences containing the one or more word-sentence combinations with a sentiment mismatch and failing the one or more readability criteria with the generated embeddings for each of the plurality of sentiment mismatch rewrite examples and the generated embeddings for each of the readability rewrite examples.

In some embodiments, the digital output document comprises content from the input document and one or more generated rewrites from the set comprising: the one or more generated first sentence rewrites, the one or more generated second sentence rewrites, and the one or more generated combined sentence rewrites configured to display as interactive selectable suggestions.

In some embodiments, the memory storing instructions and the one or more processors configured to execute the instructions further cause the system to display one or more sentiment metrics and one or more readability metrics.

In some embodiments, the one or more sentiment metrics comprise the percentage of each type of word sentiment out of the identified plurality of words.

In some embodiments, the one or more readability metrics comprise a count of each readability score value from a plurality of readability scores corresponding to each of the identified plurality of sentences.

In some embodiments: receiving the data representing the input document comprises intercepting an instruction to publish the input document; and the instructions further cause the system to: in response to intercepting the instruction to publish the input document, automatically pausing publication of the input document during application of the sentiment mismatch data processing operation and the readability data processing operation; causing display, via a graphical user interface, of the one or more generated combined sentence rewrites; receiving, via the graphical user interface, a user input comprising an instruction to accept one or more of the combined sentence rewrites; and after generating the digital output document comprising the one or more generated combined sentence rewrites, wherein the generating the digital output document is based on the user input comprising the instruction to accept the one or more of the combined sentence rewrites, automatically publishing the digital output document in accordance with the intercepted instruction to publish the input document.

In some embodiments, a method for generating sentiment sentence rewrites and readability sentence rewrites for one or more sentences in an input document is provided, the method performed by a system comprising memory and one or more processors, the method comprising: receiving data representing the input document; identifying a plurality of sentences in the input document and a plurality of words corresponding to each of the identified plurality of sentences; applying a sentiment mismatch data processing operation based on the identified plurality of sentences and the identified plurality of words to determine that one or more word-sentence combinations with a sentiment mismatch are present; applying a readability data processing operation based on the identified plurality of sentences to determine that one or more sentences of the identified plurality of sentences fail one or more readability criteria; in accordance with the determination that one or more word-sentence combinations with a sentiment mismatch are present and the determination that one or more sentences of the identified plurality of sentences fail one or more readability criteria, generating one or more combined sentence rewrites for one or more sentences of the identified plurality of sentences containing the one or more word-sentence combinations with a sentiment mismatch and failing the one or more readability criteria, wherein the one or more combined sentence rewrites are based on a plurality of sentiment mismatch rewrite examples and a plurality of readability rewrite examples; storing the one or more generated combined sentence rewrites in memory; and generating and displaying a digital output document comprising the one or more generated combined sentence rewrites.

In some embodiments, a non-transitory computer-readable storage medium storing instructions for generating sentiment sentence rewrites and readability sentence rewrites for one or more sentences in an input document is provided, wherein, when executed by system comprising memory and one or more processors, the instructions cause the system to: receive data representing the input document; identify a plurality of sentences in the input document and a plurality of words corresponding to each of the identified plurality of sentences; apply a sentiment mismatch data processing operation based on the identified plurality of sentences and the identified plurality of words to determine whether one or more word-sentence combinations with a sentiment mismatch are present; apply a readability data processing operation based on the identified plurality of sentences to determine whether one or more sentences of the identified plurality of sentences fail one or more readability criteria; in accordance with a determination that one or more word-sentence combinations with a sentiment mismatch are present and a determination that one or more sentences of the identified plurality of sentences do not fail one or more readability criteria, generate one or more first sentence rewrites for one or more sentences of the identified plurality of sentences containing the one or more word-sentence combinations with a sentiment mismatch, wherein the one or more first sentence rewrites are based on a plurality of sentiment mismatch rewrite examples; in accordance with a determination that one or more word-sentence combinations with a sentiment mismatch are not present and a determination that one or more sentences of the identified plurality of sentences fail one or more readability criteria, generate one or more second sentence rewrites for the one or more sentences that fail the one or more readability criteria, wherein the one or more second sentence rewrites are based on a plurality of readability rewrite examples; in accordance with a determination that one or more word-sentence combinations with a sentiment mismatch are present and a determination that one or more sentences of the identified plurality of sentences do fail one or more readability criteria, generate one or more combined sentence rewrites for one or more sentences of the identified plurality of sentences containing the one or more word-sentence combinations with a sentiment mismatch and failing the one or more readability criteria, wherein the one or more combined sentence rewrites are based on the plurality of sentiment mismatch rewrite examples and the plurality of readability rewrite examples; store one or more generated rewrites from the set comprising: the one or more generated first sentence rewrites, the one or more generated second sentence rewrites, and the one or more generated combined sentence rewrites in memory; and generate and display a digital output document comprising one or more generated rewrites from the set comprising: the one or more generated first sentence rewrites, the one or more generated second sentence rewrites, and the one or more generated combined sentence rewrites.

In some embodiments, a system for generating sentiment sentence rewrites and readability sentence rewrites for one or more sentences in an input document is provided, the system comprising memory storing instructions and one or more processors configured to execute the instructions to cause the system to: receive data representing the input document; identify a plurality of sentences in the input document and a plurality of words corresponding to each of the identified plurality of sentences; apply a sentiment mismatch data processing operation based on the identified plurality of sentences and the identified plurality of words; apply a readability data processing operation based on the identified plurality of sentences; generate one or more combined sentence rewrites for the input document, wherein the one or more combined sentence rewrites are based on a plurality of sentiment mismatch rewrite examples and a plurality of readability rewrite examples; store one or more generated combined sentence rewrites in memory; and generate and display a digital output document comprising one or more generated combined sentence rewrites.

In some embodiments, a method for generating sentiment sentence rewrites and readability sentence rewrites for one or more sentences in an input document is provided, the method performed by a system comprising memory and one or more processors, the method comprising: receiving data representing the input document; identifying a plurality of sentences in the input document and a plurality of words corresponding to each of the identified plurality of sentences; applying a sentiment mismatch data processing operation based on the identified plurality of sentences and the identified plurality of words; applying a readability data processing operation based on the identified plurality of sentences; generating one or more combined sentence rewrites for the input document, wherein the one or more combined sentence rewrites are based on a plurality of sentiment mismatch rewrite examples and a plurality of readability rewrite examples; storing the one or more generated combined sentence rewrites in memory; and generating and displaying a digital output document comprising the one or more generated combined sentence rewrites.

In some embodiments, a non-transitory computer-readable storage medium storing instructions for generating sentiment sentence rewrites and readability sentence rewrites for one or more sentences in an input document, wherein, when executed by system comprising memory and one or more processors, the instructions cause the system to: receive data representing the input document; identify a plurality of sentences in the input document and a plurality of words corresponding to each of the identified plurality of sentences; apply a sentiment mismatch data processing operation based on the identified plurality of sentences and the identified plurality of words; apply a readability data processing operation based on the identified plurality of sentences; generate one or more combined sentence rewrites for the input document, wherein the one or more combined sentence rewrites are based on a plurality of sentiment mismatch rewrite examples and a plurality of readability rewrite examples; store one or more generated combined sentence rewrites in memory; and generate and display a digital output document comprising one or more generated combined sentence rewrites.

In some examples, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for generating sentiment sentence rewrites and readability sentence rewrites for one or more sentences in an input document, according to some examples.

FIG. 2 illustrates an exemplary method for generating sentiment sentence rewrites and readability sentence rewrites for one or more sentences in an input document, according to some examples.

FIG. 3 illustrates an exemplary method for generating sentence rewrites for sentences containing an identified word-sentence sentiment mismatch, according to some examples.

FIG. 4 illustrates an exemplary method for generating sentence rewrites for sentences failing readability criteria, according to some examples.

FIG. 5 illustrates an exemplary sentiment metrics display, according to some examples.

FIG. 6 illustrates an exemplary readability metrics display, according to some examples.

FIG. 7 illustrates a system 700 for reviewing and executing publication of documents, in accordance with some embodiments.

FIG. 8 illustrates an exemplary computing system, according to some examples.

### DETAILED DESCRIPTION

As described above, it can be difficult to manually identify and rewrite sentences for clearer sentiment and improved readability while maintaining accuracy and key terms, particularly in widely distributed, specialized documents that are likely to be subject to third-party automated analyses that trigger automatic subsequent action in accordance with document content. Accordingly, provided herein are systems and methods for automatically analyzing documents and generating sentiment sentence rewrites and readability sentence rewrites for one or more sentences in an input document tailored to its subject matter.

The described systems may receive an input document and automatically determining whether readability and/or sentiment criteria for the document are satisfied. If said criteria are not satisfied, the system may automatically block electronic publication of the document until said issues are resolved. To resolve said issues, the system may automatically generate and propose and/or apply one or more rewrites for the document.

The system may generate sentiment sentence rewrites and readability sentence rewrites based on a sentiment mismatch analysis and a readability analysis of the input document, respectively. When receiving an input document, the described systems and methods may parse the input document to identify each sentence and word in the document.

When generating sentiment sentence rewrites, the system may apply a sentiment mismatch analysis for each identified sentence in the input document. The sentiment mismatch analysis may include determining the sentiment of a sentence and each word in that sentence, then identifying one or more word-sentence combinations where the sentiments do not match. The sentiment of a sentence and/or word may be determined, at least partly, based on a list of key terms related to the subject matter of the input document. Thus, the described system may prevent erroneous sentiment analysis, and rewrites, by distinguishing key terms that may have a different sentiment in common language and/or when discussing other subject matter.

When generating readability sentence rewrites, the described system may apply a readability analysis for each identified sentence in the input document. The readability analysis may include determining a readability score for a sentence and whether that readability score fails one or more readability criteria. The readability criteria may include a lower readability score threshold and/or an upper readability score threshold, ensuring each sentence remains within a readability range for the intended audience of the document. Thus, the described systems and methods may enable improved identification and correction of readability issues by performing a readability analysis at a sentence-by-sentence level, which may prevent serious readability issues in one sentence from being diluted by excellent readability of other sentences in the input document.

The described system may generate sentiment sentence rewrites and readability sentence rewrites by providing issue sentences identified by the sentiment mismatch analysis and readability analysis, respectively, to one or more machine learning and/or generative AI models along with corresponding example rewrites. For instance, a sentiment sentence rewrite may be generated by providing sentences with one or more word-sentence combinations with mismatched sentiment and a number of examples of sentences rewritten for sentiment matching to one or more machine learning and/or generative AI models. The examples of sentences rewritten for sentiment matching may be selected from a list of examples as those most similar to the sentence or sentences at issue. Similarly, a readability sentence rewrite may be generated by providing sentences with readability scores that fail one or more readability criteria and a number of examples of sentences rewritten for readability to one or more machine learning and/or generative AI models. The examples of sentences rewritten for readability may be selected from a list of examples as those most similar to the sentence or sentences at issue. Thus, the described systems and methods may generate sentence rewrites based on tailored examples, which may enable improved rewrites by providing rewrites of close equivalents of sentence or sentences at issue.

The described system may further generate combined sentence rewrites based on the generated sentiment sentence rewrites and readability sentence rewrites. For instance, if both a sentiment mismatch rewrite and a readability rewrite were generated for a single sentence, then a combined sentence rewrite may incorporate portions from both the mismatch and readability rewrites.

The described system may store the generated sentence rewrites (e.g., sentiment sentence rewrites, readability sentence rewrites, combined sentence rewrites) in memory and display the generated sentence rewrites to a user in an output document. The generated sentence rewrites may be displayed to a user in an output document as suggestions and/or replacements of the sentences corresponding to the sentence rewrites. The described systems and methods may further display one or more sentiment metrics and one or more readability metrics to a user, which may enable the user to identify areas for improvement of their writing style.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

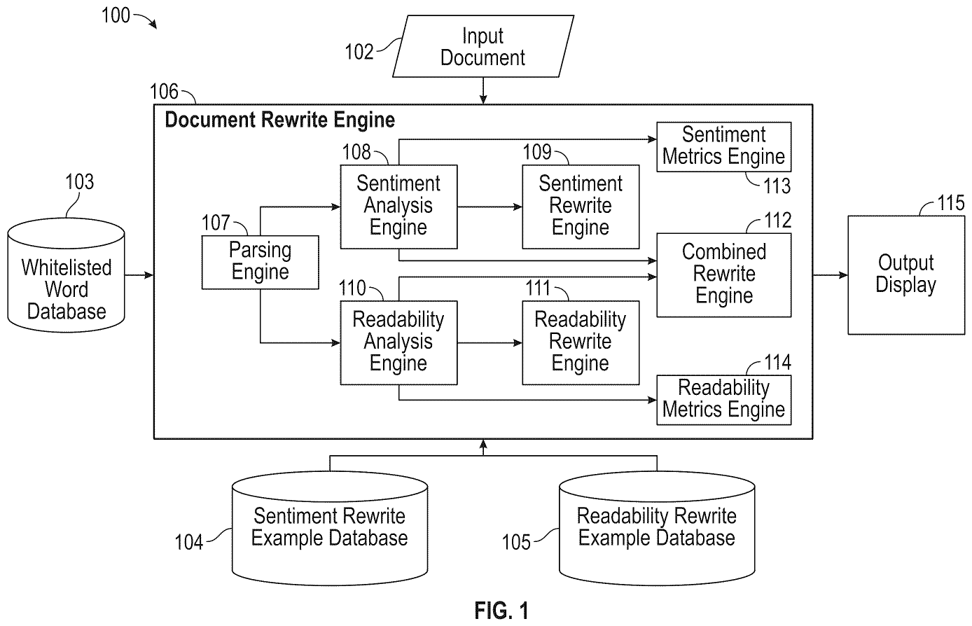

FIG. 1 illustrates an exemplary system 100 for generating sentiment sentence rewrites and readability sentence rewrites for one or more sentences in an input document, according to some examples. System 100 may include at least one input document 102. Input document 102 can be any written document containing one or more words organized into one or more sentences. Input document 102 may be a document intended for public or internal use. For example, input document 102 may be a financial document (e.g., an earnings report), a policy document (e.g., a policy memorandum describing shifting policy and operations in the organization), or any other type of document produced by an organization. Input document may be a digital document in any suitable file format (e.g., .PDF, .DOCX, etc.)

The system 100 may include a whitelisted word database 103. Whitelisted word database 103 may include servers or databases that store one or more words and/or phrases that should not be rewritten by the document rewrite engine 106 on storage devices such as USB drives, hard drives, or storage disks. The words and phrases in whitelisted word database 103 may include key terms in one or more subject matters to which an input document may pertain. In some examples, the words and phrases in whitelisted word database 103 may be developed by professionals and/or experts in one or more subject matters to which an input document may pertain.

The system 100 may include sentiment rewrite example database 104. Sentiment rewrite example database 104 may include servers or databases that store one or more examples of sentences that have been rewritten for improved sentiment and/or sentiment matching on storage devices such as USB drives, hard drives, or storage disks. Each example in sentiment rewrite example database 104 may include a before sentence and an after sentence. Each before sentence may be a sentence having poor sentiment and/or one or more word-sentence sentiment mismatches. Each after sentence may be a sentence that was rewritten to improve sentiment and/or remove word-sentence sentiment mismatches while maintaining the context and factual accuracy of the sentence. One or more after sentences may have been generated by professionals and/or experts in one or more subject matters to which an input document may pertain and/or the system described herein. In some embodiments, sentiment rewrite example database 104 may store metadata regarding the one or more rewritten sentence examples, wherein the metadata may indicate what sentiment issues were addressed, in what manner said issues were addressed, and/or what AI models were used to detect and/or address said issues.

The system 100 may include readability rewrite example database 105. Readability rewrite example database 105 may include servers or databases that store one or more examples of sentences that have been rewritten for improved readability on storage devices such as USB drives, hard drives, or storage disks. Each example in readability rewrite example database 105 may include a before sentence and an after sentence. Each before sentence may be a sentence having poor readability and/or failing one or more readability criteria. Each after sentence may be a sentence that was rewritten to improve readability and/or satisfy one or more readability criteria while maintaining the context and factual accuracy of the sentence. One or more after sentences may have been generated by professionals and/or experts in one or more subject matters to which an input document may pertain and/or the system described herein. In some embodiments, readability rewrite example database 105 may store metadata regarding the one or more rewritten sentence examples, wherein the metadata may indicate what readability issues were addressed, in what manner said issues were addressed, and/or what AI models were used to detect and/or address said issues.

The system 100 may include document rewrite engine 106, which may comprise one or more processors configured to perform the functionalities described herein. While document rewrite engine 106 is shown illustratively as comprising various sub-engines, any of the corresponding functionalities described herein may, in some embodiment, be performed by any combination of any one or more processors.

Document rewrite engine 106 may be configured to receive an input document 102 and/or communicate with whitelisted word database 103, sentiment rewrite example database 104, and/or readability rewrite example database 105. Document rewrite engine 106 may include a parsing engine 107, sentiment analysis engine 108, sentiment rewrite engine 109, readability analysis engine 110, readability rewrite engine 111, combined rewrite engine 112, sentiment metrics engine 113, and/or readability metrics engine 114. Document rewrite engine 106 may be configured to generate rewrites for one or more sentences in input document 102 to improve sentence sentiment and/or readability and/or generate sentiment and/or readability metrics. Document rewrite engine 106 may be configured to communicate with an output display 115 to display the generated rewrites and/or metrics to a user.

Document rewrite engine 106 in system 100 may include a parsing engine 107. Parsing engine 107 may be configured to identify one or more sentences and/or one or more words in input document 102 communicated through document rewrite engine 106. Parsing engine 107 may identify sentences and/or words by tokenizing the text in input document 102. Parsing engine 107 may perform further transformations of the tokenized text to ensure accurate sentence and/or word splitting. For example, parsing engine 107 may include a lookup table for recognizing common abbreviations so they are identified as single words rather than multiple words or sentences. Parsing engine 107 may use any process and/or algorithm known in the art to perform sentence splitting and/or word splitting, including any pre-trained AI model and/or tokenizer library.

Document rewrite engine 106 in system 100 may include a sentiment analysis engine 108. Sentiment analysis engine 108 may be configured to receive one or more sentences of input document 102 identified by parsing engine 107. For each sentence identified by parsing engine 107, sentiment analysis engine 108 may perform sentence-level sentiment analysis and/or word-level sentiment analysis. Sentence-level analysis may include identifying an intended sentiment of the identified sentence. For example, sentence-level analysis may identify an intended sentiment of a sentence to be negative, positive, strong modal (e.g., with a confident tone and strong stance), weak modal (e.g., ambiguous or using passive voice), and/or litigious. Word-level sentiment analysis may include identifying the sentiment conveyed by one or more words in the identified sentence. For example, word-level analysis may identify the sentiment conveyed by a particular word to be negative, constraining, uncertain, positive, strong modal, weak modal, litigious, and/or part of a red flag phrase (e.g., phrases linked to negative stock price movement). Sentence and/or word sentiments may be identified using a lexicon (e.g., Loughran-McDonald financial lexicon) and/or a language model (e.g., the FinBERT model).

Based on the identified sentence and/or word sentiments, sentiment analysis engine 108 may identify one or more word-sentence sentiment mismatches. Sentiment analysis engine 108 may identify one or more word-sentence sentiment mismatches by comparing a sentence's sentiment with the sentiment of each word in that sentence. For example, sentiment analysis engine 108 may identify a word-sentence sentiment mismatch when it compares a positive sentiment sentence with a negative sentiment word in that sentence. However, sentiment analysis engine 108 may not identify a word-sentence sentiment mismatch when it compares a strong modal sentence with a positive sentiment word in that sentence. In some embodiments, mismatches may be determined according to one or more predetermined rules that determine sentiment classifications within certain categories or groups to be matching, and sentiment classifications outside those categories or groups to be mismatching. In some embodiments, mismatches may be determined according to one or more predetermined threshold-based comparisons, for example by determining a mismatch when a sentence sentiment score and one or more word sentiment scores are not within a maximum threshold difference of one another. In some embodiments, the kinds of mismatches that trigger a mismatch determination by the system may be defined, selected, set, and/or otherwise configured in accordance with user input provided by a user via a graphical user interface.

In some examples, the sentiment analysis engine 108 may remove any word-sentence sentiment mismatches that include words in the whitelisted word database 103 as communicated through document rewrite engine 106, which may prevent key terms from being erroneously rewritten. In another example, the sentiment analysis engine 108 may identify one or more word-sentence sentiment mismatches by comparing a sentence's sentiment with the sentiment of each word in the sentence except words in the whitelisted word database 103, which may prevent key terms from being associated with an incorrect sentiment. Thus, sentiment analysis engine 108 may identify one or more sentences containing one or more word-sentence combinations with a sentiment mismatch.

Document rewrite engine 106 in system 100 may include a sentiment rewrite engine 109. Sentiment rewrite engine 109 may be configured to generate one or more sentiment sentence rewrites for one or more sentences containing one or more word-sentence combinations with a sentiment mismatch received from sentiment analysis engine 108 based on one or more sentiment rewrite examples received from sentiment rewrite example database 104. Sentiment rewrite engine 109 may compare the one or more sentences received from sentiment analysis engine 108 with one or more sentiment rewrite examples received from sentiment rewrite example database 104 by performing a lexical and/or semantic search. For example, sentiment rewrite engine 109 may identify one or more sentiment rewrite examples relevant and/or similar to each sentence received from the sentiment analysis engine 108 by performing a semantic search for each sentence in the sentiment rewrite example database 104. A semantic search may be performed using natural language processing, machine learning, and/or other searching algorithms. For example, semantic search may be performed by embedding or otherwise generating representative vectors for each sentiment rewrite example and the one or more sentences received from sentiment analysis engine 108, then it may use a cosine comparison, or another comparison metric, to determine which sentiment rewrite examples are closest or most similar to the sentences received from sentiment analysis engine 108. Sentiment rewrite engine 109 may select a predefined number of sentiment rewrite examples based on the search of the sentiment rewrite example database 104. For example, sentiment rewrite engine 109 may select a predefined number of sentiment rewrite examples that are most relevant and/or similar to each sentence received from the sentiment analysis engine 108.

Sentiment rewrite engine 109 may generate one or more sentiment sentence rewrites for one or more sentences containing one or more word-sentence combinations with a sentiment mismatch received from sentiment analysis engine 108. Sentiment rewrite engine 109 may generate one or more sentiment sentence rewrites by ingesting or otherwise processing each sentence with sentiment rewrite examples retrieved from sentiment rewrite example database 104 and custom instructions into one or more machine learning and/or generative AI models. The generative AI models may be trained, instructed or otherwise configured to maintain all factual and contextual information from the one or more sentences containing one or more word-sentence combinations with a sentiment mismatch while removing and/or replacing the words in the word-sentence combinations with a sentiment mismatch. This way, the sentiment rewrite engine 109 may generate sentence rewrites that convey the intended sentiment of the sentence while remaining consistent with the intended message. Sentiment rewrite engine 109 may optionally provide one or more words from whitelisted word database 103 to one or more of the machine learning and/or generative AI models. One or more machine learning and/or generative AI models may optionally be configured to ignore (e.g., not remove or replace) words and/or phrases containing words from the whitelisted word database 103. This way, the sentiment rewrite engine 109 may generate sentence rewrites without removing, replacing, or otherwise confusing key terms related to the subject matter of the document.

Due to the nature of generative AI and large language models, it is possible for the generative AI model in sentiment rewrite engine 109 to output a sentence rewrite that still contains one or more original words in the word-sentence combinations with a sentiment mismatch, and/or that introduces one or more new words with a sentiment mismatch. Therefore, sentiment rewrite engine 109 may re-evaluate output from the generative AI model for new or lingering word-sentence combinations with a sentiment mismatch. Sentiment rewrite engine 109 may check whether one or more original words in the word-sentence combinations with a sentiment mismatch are still present and/or if one or more new words with a sentiment mismatch have been introduced. If any such word-sentence combinations with a sentiment mismatch are detected, then sentiment rewrite engine 109 may prompt the generative AI model with the pervious generative AI model sentence rewrite output and custom instructions to again maintain all factual and contextual information from the previous sentence rewrite while removing and/or replacing the words in the word-sentence combinations with a sentiment mismatch. Sentiment rewrite engine 109 may re-evaluate the second output from the generative AI model for one or more new or previously identified word-sentence combinations with a sentiment mismatch. This process may continue until no word-sentence combinations with a sentiment mismatch are identified or a predetermined number of re-evaluations have been performed. If no word-sentence combinations with a sentiment mismatch are identified in an output from the generative AI model, then the output may be produced by sentiment rewrite engine 109 as a sentiment sentence rewrite. If there are still one or more word-sentence combinations with a sentiment mismatch after a predetermined number of re-evaluations has been performed, then sentiment rewrite engine 109 may not produce a sentiment sentence rewrite for the original sentence. Sentiment rewrite engine 109 may designate the original sentence as fundamentally difficult to rewrite.

Sentiment sentence rewrites generated by sentiment rewrite engine 109 may optionally be stored with the original sentence containing one or more word-sentence combinations with a sentiment mismatch in sentiment rewrite example database 104 to be used as an example for future sentiment sentence rewrites.

Document rewrite engine 106 in system 100 may include a readability analysis engine 110. Readability analysis engine 110 may be configured to receive one or more sentences of input document 102 identified by parsing engine 107. For each sentence identified by parsing engine 107, readability analysis engine 110 may perform a readability analysis. Readability analysis may include analyzing the readability of a sentence, and the corresponding comprehension level required to appropriately understand the sentence, by calculating a readability score. In some examples, the readability score may be based on the number of words in the sentence, the number of complex words in the sentence, the sum of the number the words in the sentence and the number of complex words in the sentence, and/or a weighted sum of the number the words in the sentence and the number of complex words in the sentence. Thus, the system may compute an index (e.g., one akin to a Fog index) that characterizes readability for an individual sentence (rather than for an entire document or entire body of text). In other examples, the readability score may be based on the average sentence length in the input document 102, the percentage of long words present in the input document 102, the sum of the average sentence length and the percentage of long words in the input document 102, and/or a Fog Index score of the input document 102.

Based on the calculated readability scores, readability analysis engine 110 may determine that the readability score of one or more sentences fails one or more readability criteria. Readability analysis engine 110 may compare the readability score of each sentence identified by parsing engine 107 against one or more readability criteria to determine whether the sentence fails one or more the readability criteria. One or more readability criteria may include predefined upper and/or lower thresholds. Upper and/or lower threshold readability criteria may be based on the reading level of the intended audience of the input document 102. In some examples, one or more readability criteria may be configurable based on the subject matter and/or intended audience of the input document 102. For example, the readability criteria for a public earnings report may be configured to pass only clearly written sentences that are at an average financial literacy reading level, whereas the readability criteria for an internal earnings report to financial officers may be configures to pass sentences at a high financial literacy reading level. One or more readability criteria may provide one or more readability criteria windows. For example, the readability criteria may be configured to pass sentences written at an 8th grade level to a 12th grade level, but not pass any sentences written outside of that range. Thus, readability analysis engine 110 may identify one or more sentences that fail one or more readability criteria.

Document rewrite engine 106 in system 100 may include a readability rewrite engine 111. Readability rewrite engine 111 may be configured to generate one or more readability sentence rewrites for one or more sentences that fail one or more readability criteria received from readability analysis engine 110 based on one or more readability rewrite examples received from readability rewrite example database 105. Readability rewrite engine 111 may compare the one or more sentences received from readability analysis engine 110 with one or more readability rewrite examples received from readability rewrite example database 105 by performing a lexical and/or semantic search. For example, readability rewrite engine 111 may identify one or more readability rewrite examples relevant and/or similar to each sentence received from the readability analysis engine 110 by performing a semantic search for each sentence in the readability rewrite example database 105. A semantic search may be performed using natural language processing, machine learning, and/or other searching algorithms. For example, semantic search may be performed by embedding or otherwise generating representative vectors for each readability rewrite example and the one or more sentences received from readability analysis engine 110, then it may use a cosine comparison, or another comparison metric, to determine which readability rewrite examples are closest or most similar to the sentences received from sentiment analysis engine 110. Readability rewrite engine 111 may select a predefined number of readability rewrite examples based on the search of the readability rewrite example database 105. For example, readability rewrite engine 111 may select a predefined number of readability rewrite examples that are most relevant and/or similar to each sentence received from the readability analysis engine 110.

Readability rewrite engine 111 may generate one or more readability sentence rewrites for one or more sentences that fail one or more readability criteria received from readability analysis engine 110 by providing each sentence with the corresponding selected readability rewrite examples received from readability rewrite example database 105 to one or more machine learning models and/or generative AI models. The generative AI models may be configured to maintain all factual and contextual information from the one or more sentences that fail one or more readability criteria while improving the readability score of the sentence. This way, the readability rewrite engine 111 may generate sentence rewrites that improve the readability of the sentence for its intended audience while remaining consistent with the intended message. Readability rewrite engine 111 may optionally provide one or more words from whitelisted word database 103 to one or more of the machine learning and/or generative AI models. One or more machine learning and/or generative AI models may optionally be configured to ignore (e.g., not remove or replace) words and/or phrases containing words from the whitelisted word database 103. This way, the readability rewrite engine 111 may generate sentence rewrites without removing, replacing, or otherwise confusing key terms related to the subject matter of the document.

Due to the nature of generative AI and large language models, it is possible for the generative AI model in readability rewrite engine 111 to output a sentence rewrite that does not sufficiently improve the readability score of the sentence. Therefore, readability rewrite engine 111 may re-evaluate output from the generative AI model for one or more readability criteria. Readability rewrite engine 111 may check whether the output still fails one or more readability criteria. If the output still fails one or more readability criteria, then readability rewrite engine 111 may prompt the generative AI model with the pervious generative AI model sentence rewrite output and custom instructions to again improve the readability score of the sentence. Readability rewrite engine 111 may re-evaluate the second output from the generative AI model for one or more readability criteria. This process may continue until the output sentence does not fail any readability criteria or a predetermined number of re-evaluations have been performed. If an output from the generative AI model does not fail any readability criteria, then the output may be produced by readability rewrite engine 111 as a readability sentence rewrite. If the output from the generative AI model still fails one or more readability criteria after a predetermined number of re-evaluations has been performed, then readability rewrite engine 111 may not produce a readability sentence rewrite for the original sentence or may produce the generative AI model output with the best readability score. Readability rewrite engine 111 may designate the original sentence as fundamentally difficult to rewrite. Readability sentence rewrites generated by readability rewrite engine 111 may optionally be stored with the original sentence that fails one or more readability criteria in readability rewrite example database 105 to be used as an example for future readability sentence rewrites.

Document rewrite engine 106 in system 100 may include a combined rewrite engine 112 configured to generate one or more combined sentence rewrites for one or more sentences containing one or more word-sentence combinations with a sentiment mismatch and failing one or more readability criteria, e.g., one or more sentences received from both sentiment analysis engine 108 and readability analysis engine 110, based on one or more sentiment rewrite examples received from sentiment rewrite example database 104 and one or more readability rewrite examples received from readability rewrite example database 105. Combined rewrite engine 112 may generate one or more combined sentence rewrites for one or more sentences containing one or more word-sentence combinations with a sentiment mismatch and failing one or more readability criteria by providing each sentence with the corresponding selected sentiment rewrite examples received from sentiment rewrite example database 104 and readability rewrite examples received from readability rewrite example database 105 to one or more machine learning models and/or generative AI models. The generative AI models may be configured to maintain all factual and contextual information from the one or more sentences containing one or more word-sentence combinations with a sentiment mismatch and failing one or more readability criteria while improving the readability score of the sentence and removing and/or replacing the words in word-sentence combinations with a sentiment mismatch. Combined rewrite engine 112 may optionally provide one or more words from whitelisted word database 103 to one or more of the machine learning and/or generative AI models. One or more machine learning and/or generative AI models may optionally be configured to ignore (e.g., not remove or replace) words and/or phrases containing words from the whitelisted word database 103.

Combined rewrite engine 112 may also be configured to generate one or more combined sentence rewrites based on sentiment sentence rewrites received from sentiment rewrite engine 109 and readability sentence rewrites received form readability rewrite engine 111. Combined rewrite engine 112 may, in some embodiments, generate a combined sentence rewrite for a particular sentence by modifying a sentiment sentence rewrite based on a readability sentence rewrite or modifying a readability sentence rewrite based on a sentiment sentence rewrite.

In some examples, combined rewrite engine 112 may communicate the combined rewrite to the sentiment analysis engine and readability analysis engine to verify the modification did not create new readability and/or sentiment mismatch issues. In some examples, combined rewrite engine 112 may generate a combined sentence rewrite for a particular sentence by providing the sentence at issue with corresponding readability rewrite examples selected by readability rewrite engine 111 above and sentiment rewrite examples selected by sentiment rewrite engine 109 above to one or more machine learning and/or generative AI models. One or more machine learning and/or generative AI models may be trained or otherwise configured to maintain all factual and contextual information from the sentence at issue while improving the readability score of the sentence and removing and/or replacing the words in word-sentence combinations with a sentiment mismatch. Combined rewrite engine 112 may optionally provide one or more words from whitelisted word database 103 to one or more of the machine learning and/or generative AI models. One or more machine learning and/or generative AI models may optionally be trained or otherwise configured to ignore (e.g., not remove or replace) words and/or phrases containing words from the whitelisted word database 103.

Document rewrite engine 106 in system 100 may include a sentiment metrics engine 113 and/or a readability metrics engine 114. Sentiment metrics engine 113 may be configured to receive data from sentiment analysis engine 108, such as the number of words in the input document 102 that convey an identified sentiment (e.g., negative). Sentiment metrics engine 113 may process data received from sentiment analysis engine 108 (e.g., by running statistical analyses) to produce metrics on the sentiment of the input document 102 (e.g., the percentage of words corresponding to each identified sentiment, the percentage of sentiment mismatched words per sentence, percentage of sentences with sentiment mismatched words per section of the input document, etc.). Readability metrics engine 114 may be configured to receive data from readability analysis engine 110, such as the readability score of each sentence. Readability metrics engine 114 may process data received from readability analysis engine 110 (e.g., by running statistical analyses) to produce metrics on the readability of the input document 102 (e.g., the average readability score of the input document, the average readability score by section of the input document, the readability grade level of the input document, the average readability score of the input document as compared to other documents written by the organization and/or other organizations in the same field, etc.).

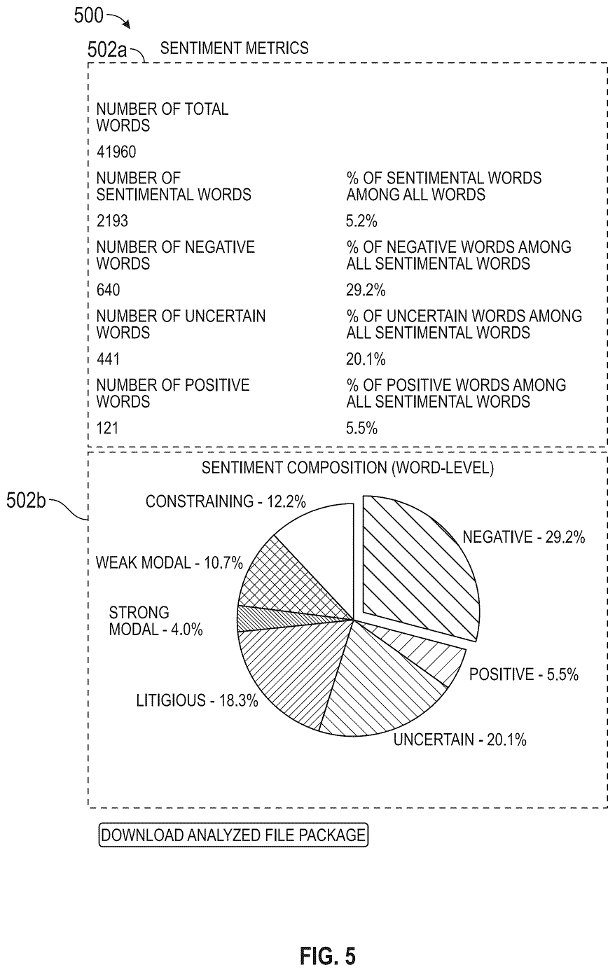

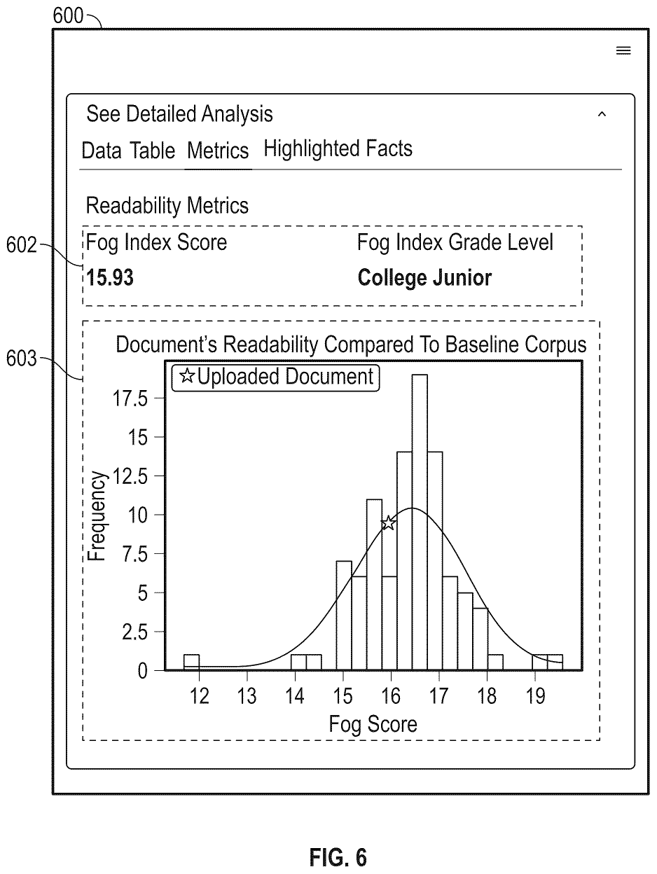

System 100 may further include an output display 115. Output display 115 may be configured to display an output document and/or sentiment and readability metrics to a user. Output display 115 may display an output document as the input document 102 where sentiment, readability, and/or combined sentence rewrites received from document rewrite engine 106 are suggested (e.g., as comments), which may enable users to review individual suggested rewrites. Output display 115 may optionally enable a user to accept or reject suggested sentence rewrites. In response to a user accepting a suggested sentence rewrite, output display 115 may replace the original sentence from input document 102 with the accepted sentence rewrite in the displayed output document. Thus, the system enables users to review possible sentence rewrites so they can tailor the document to the needs of the organization. Output display 115 may also display sentiment and/or readability metrics to a user in human readable format (e.g., tables, graphs, etc.), which may enable users to review their writing styles for future improvement. Exemplary sentiment and readability metric output displays are described in further detail below with reference to FIG. 5 and FIG. 6, respectively. In some embodiments, output display 115 may provide a graphical user interface configured to display rewrites, suggested rewrites, metrics, and/or other information to a user, and configured to accept inputs from the user regarding submission of documents to be published, configuration of the databases and/or settings for document rewrite engine 106, and/or acceptance/rejection/modification of proposed rewrites.

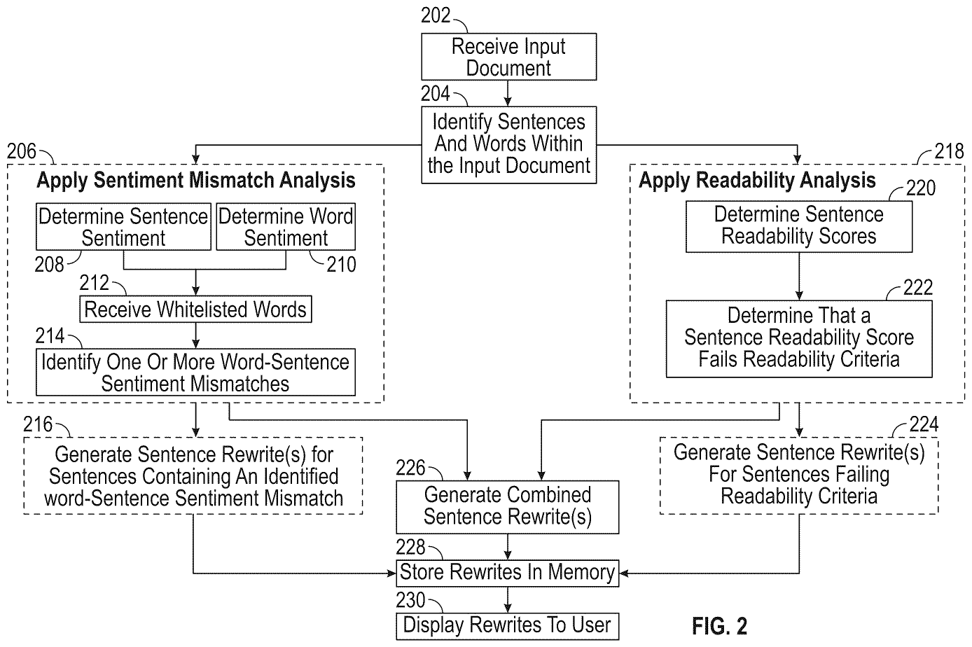

FIG. 2 illustrates an exemplary method 200 for generating sentiment sentence rewrites and readability sentence rewrites for one or more sentences in an input document, according to some examples. Method 200 is performed, for example, using one or more electronic devices implementing a software platform. In some examples, method 200 is performed using a client-server system, and the blocks of method 200 are divided up in any manner between the server and a client device. In other examples, the blocks of method 200 are divided up between the server and multiple client devices. In method 200, some blocks are, optionally, combined; the order of some blocks is, optionally, changed; and some blocks are, optionally, omitted. In some examples, additional steps may be performed in combination with the method 200. Accordingly, the operations illustrated (and described in greater detail below) are exemplary by nature and, as such, should not be viewed as limiting.

The method 200 may begin at step 202, wherein step 202 includes receiving an input document. The input document may be any written document containing one or more words organized into one or more sentences. The input document may be a document intended for public or internal use. For example, the input document may be a financial document, such as an earnings report, a policy document, such as a policy memorandum describing shifting policy and operations in the organization, or any other type of document produced by an organization. In some examples, the input document is input document 102 described above with reference to FIG. 1.

The method 200 may include step 204. Step 204 includes identifying sentences and words within the input document. Sentences and words within the input document may be identified by a system component that can parse large amounts of text, such as parsing engine 107 described above with reference to FIG. 1. As described above with reference to FIG. 1, sentences and/or words may be identified by tokenizing the text in the input document and/or performing further transformations.

After identifying sentences and words within the input document, the method 200 may optionally include step 206 and/or step 218. Step 206 includes applying a sentiment mismatch analysis to each sentence identified in step 204. A sentiment mismatch analysis may be applied by a system component that can identify the sentiments of sentences and/or words, such as sentiment analysis engine 108 described above with reference to FIG. 1. As described above with reference to FIG. 1, applying a sentiment mismatch analysis may include multiple steps, such as steps 208, 210, 212, and 214.

When applying a sentiment mismatch analysis at step 206, the method 200 may first perform steps 208 and 210. Step 208 includes determining a sentence sentiment for each sentence identified in step 204. As described above with reference to FIG. 1, determining a sentence sentiment may include identifying whether the intended sentiment of the sentence is negative, positive, strong modal, weak modal, and/or litigious. Similarly, step 210 includes determining a word sentiment for each word in a sentence identified in step 204. As described above with reference to FIG. 1, determining a word sentiment may include identifying whether the sentiment conveyed by the word is negative, constraining, uncertain, positive, etc.

When applying a sentiment mismatch analysis at step 206, the method 200 may proceed from steps 208 and 210 to step 212. Step 212 includes receiving whitelisted words. As described above with reference to FIG. 1, whitelisted words may include one or more words and/or phrases that should not be rewritten, such as key terms in one or more subject matters to which the input document received at step 202 may pertain. In some examples, whitelisted words can be received from a storage medium, such as database 103 described above with reference to FIG. 1.

When applying a sentiment mismatch analysis at step 206, the method 200 may proceed from step 212 to step 214. Step 214 include identifying one or more word-sentence sentiment mismatches. As described above with reference to FIG. 1, one or more word-sentence sentiment mismatches may be identified by comparing the sentiment of a sentence identified in step 208 with the sentiment of each word in that sentence identified in step 210. For example, a word-sentence sentiment mismatch may be identified at step 214 when a sentence with a strong modal sentiment is compared with a word in that sentence conveying an uncertain sentiment. In some examples, step 214 may not include identifying word-sentence sentiment mismatches when the word is a whitelisted word received at step 212.

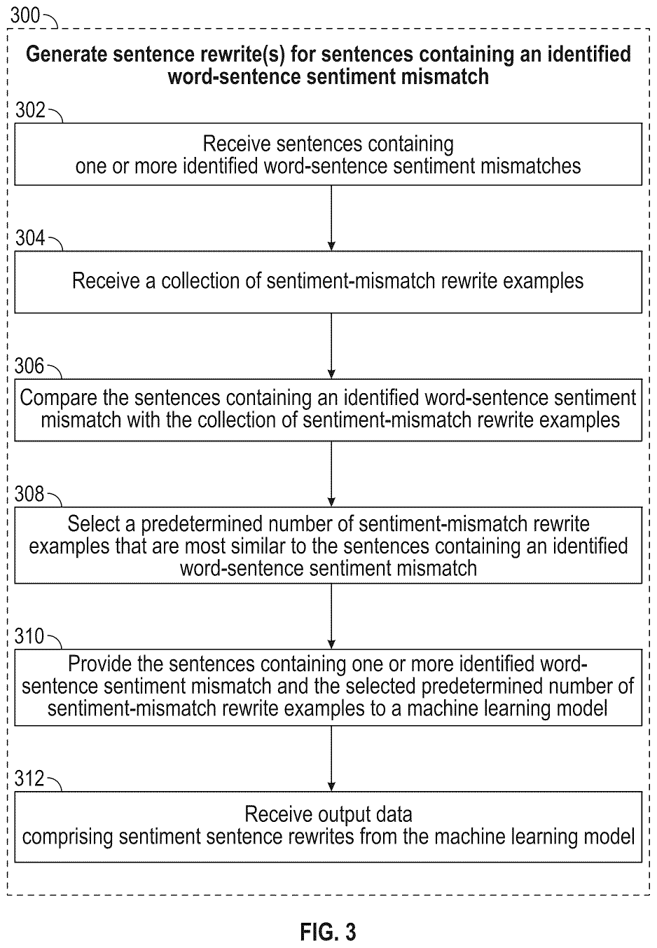

After applying a sentiment mismatch analysis, the method 200 may include step 216. Step 216 includes generating one or more sentiment sentence rewrites for the sentences of the input document that contain an identified word-sentence sentiment mismatch. One or more sentiment sentence rewrites may be generated by a device or system component such as sentiment rewrite engine 109 described above with reference to FIG. 1. As described above with reference to FIG. 1, generating sentiment sentence rewrites may include multiple steps, as described in further detail below with reference to FIG. 3.

After identifying sentences and words within the input document at step 204, the method 200 may optionally include step 218 before or simultaneously with steps 206-216. Step 218 includes applying a readability analysis to each sentence identified in step 204. A readability analysis may be applied by a system component that can determine the readability score of a sentence, such as readability analysis engine 110 described above with reference to FIG. 1. As described above with reference to FIG. 1, applying a readability analysis may include multiple steps, such as steps 220 and 222.

When applying a readability analysis at step 218, the method 200 may include step 220. Step 220 includes determining sentence readability scores for each sentence identified in step 204. As described above with reference to FIG. 1, determining a readability score may include computing a composite of the average sentence length in the input document received at step 202, the percentage of long words present in the input document, and the sum of the average sentence length and the percentage of long words.

When applying a readability analysis at step 218, the method 200 may proceed from step 220 to step 222. Step 222 includes determining that a sentence readability score fails readability criteria. As described above with reference to FIG. 1, determining that a sentence readability score fails one or more readability criteria may include comparing the readability score of a sentence against an upper and lower readability threshold based on the subject matter and intended audience of the input document received at step 202.

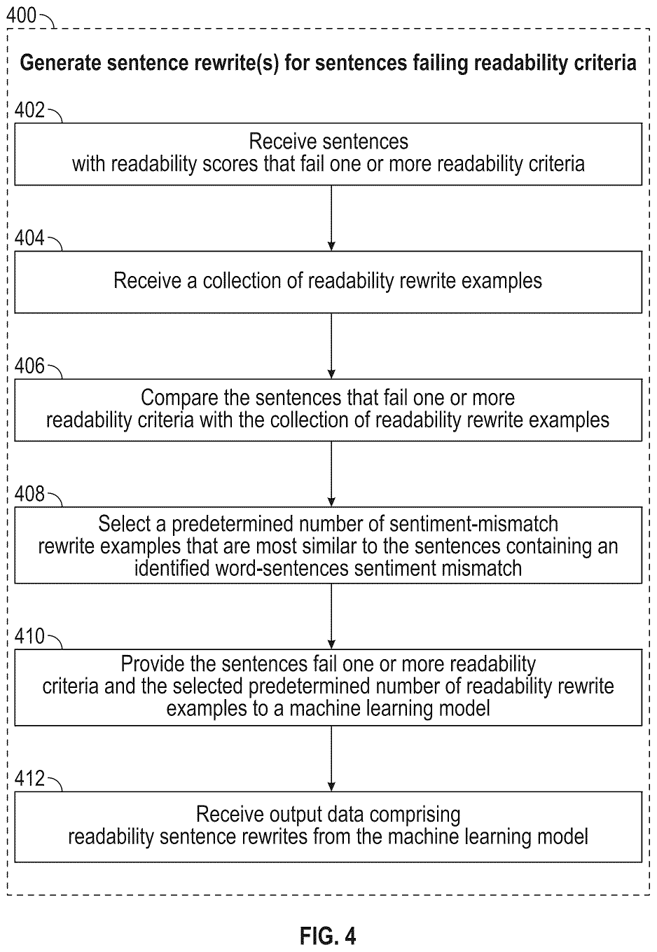

After applying a readability analysis, the method 200 may include step 224. Step 224 includes generating one or more readability sentence rewrites for the sentences of the input document that fail one or more readability criteria. One or more readability sentence rewrites may be generated by a device or system component such as readability rewrite engine 111 described above with reference to FIG. 1. As described above with reference to FIG. 1, generating readability sentence rewrites may include multiple steps, as described in further detail below with reference to FIG. 4.

After generating sentiment sentence rewrites at step 216 and readability sentence rewrites at step 224, the method 200 may include step 226. Step 226 includes generating combined sentence rewrites for sentences that both contain one or more word-sentence combinations with a sentiment mismatch and fail one or more readability criteria. As described above with reference to FIG. 1, generating combined sentence rewrites may include modifying a sentiment sentence rewrite based on a readability sentence rewrite corresponding to the same original sentence from the input document, or vice versa. In some examples, combined sentence rewrites may be generated by one or more machine learning and/or generative AI models by ingesting or otherwise processing each sentence with sentiment rewrite examples, readability rewrite examples, and custom instructions, as described above with reference to FIG. 1.

As noted above with respect to FIG. 1, sentence rewrites may be evaluated after they are generated to determine whether any word-sentence sentiment mismatches remain or have been newly introduced, and/or whether any readability criteria failures remain or have been newly introduced. In accordance with the sentence rewrite still failing sentiment or readability criteria, one or more new sentence rewrites may be iteratively generated.

After generating sentiment sentence rewrites at step 215, readability sentence rewrites at step 224, and combined sentence rewrites at step 226, the method 200 may include step 228. Step 228 includes storing sentiment sentence rewrites, readability sentence rewrites, and combined sentence rewrites in memory. Storing sentence rewrites in memory may include associating each sentence rewrite with the original sentence from the input document corresponding to that sentence rewrite. In some examples, sentence rewrites may be stored as suggestions in an output document that is a copy of the input document received at step 202. In other examples, sentence rewrites may be stored in an output document that is a copy of the input document as replacements for the corresponding original sentences.

The method 200 may include step 230. Step 230 includes displaying sentence rewrites to a user. Sentence rewrites may be displayed to a user by a device or system component such as output display 115 described above with reference to FIG. 1. As described above with reference to FIG. 1, displaying sentence rewrites to a user may include displaying an output document stored at step 226 and optionally enabling a user to accept or reject any suggested sentence rewrites. In response to a user accepting a suggested sentence rewrite, the exemplary system performing method 200 may display the sentence rewrite to the user by replacing the original sentence from the input document with the accepted sentence rewrite in the displayed output document.

FIG. 3 illustrates an exemplary method for generating sentence rewrites for sentences containing an identified word-sentence sentiment mismatch, according to some examples. Method 300 is performed, for example, using one or more electronic devices implementing a software platform. In some examples, method 300 is performed using a client-server system, and the blocks of method 300 are divided up in any manner between the server and a client device. In other examples, the blocks of method 300 are divided up between the server and multiple client devices. In method 300, some blocks are, optionally, combined; the order of some blocks is, optionally, changed; and some blocks are, optionally, omitted. In some examples, additional steps may be performed in combination with the method 300. Accordingly, the operations illustrated (and described in greater detail below) are exemplary by nature and, as such, should not be viewed as limiting.

Method 300 may be performed by a device or system component that can generating sentiment sentence rewrites, such as sentiment rewrite engine 109 described above with reference to FIG. 1. Method 300 may include step 302, wherein step 302 includes receiving sentences containing one or more identified word-sentence sentiment mismatches. Sentences containing one or more identified word-sentence sentiment mismatches may be received from a device or system component that can identify one or more word-sentence sentiment mismatches, such as sentiment analysis engine 108 described above with reference to FIG. 1. Method 300 may include step 304, wherein step 304 includes receiving a collection of sentiment-mismatch rewrite examples. Sentiment-mismatch rewrite examples may be received form a storage device, such as sentiment rewrite example database 104 described above with reference to FIG. 1. As described above with reference to FIG. 1, sentiment rewrite examples received at step 304 may include before and after sentences exemplifying how a sentence may be rewritten to improve sentiment and/or remove word-sentence sentiment mismatches while maintaining the context and factual accuracy of the sentence.

Method 300 may include step 306. Step 306 includes comparing the sentences containing one or more identified word-sentence sentiment mismatches received at step 302 with the collection of sentiment-mismatch rewrite examples received at step 304. As described with reference to FIG. 1, comparing the sentences received at step 302 with the collection of sentiment-mismatch rewrite examples received at step 304 may include performing a lexical and/or semantic search. Method 300 may include step 308, wherein step 308 includes selecting a predetermined number of sentiment-mismatch rewrite examples that are most similar to the sentences containing an identified word-sentence sentiment mismatch. As described with reference to FIG. 1, selecting a predetermined number of sentiment-mismatch rewrite examples may include selecting the predefined number of sentiment rewrite examples that are most relevant and/or similar to each sentence received at step 302.

Method 300 may include step 310. Step 310 includes providing the sentences containing one or more identified word-sentence sentiment mismatches received at step 302 and the predetermined number of sentiment-mismatch rewrite examples selected at step 308 to one or more machine learning and/or generative AI models. As described with reference to FIG. 1, one or more machine learning and/or generative AI models may be trained or otherwise configured to maintain all factual and contextual information from sentences containing one or more identified word-sentence sentiment mismatches while removing and/or replacing the words in the word-sentence combinations with a sentiment mismatch. The machine learning and/or generative AI models may be trained or otherwise configured to follow or infer from the sentiment-mismatch rewrite examples how to rewrite the sentences containing one or more identified word-sentence sentiment mismatches, or otherwise use the sentiment-mismatch rewrite examples in few-shot learning. With few-shot learning, input/output pairs may be provided into the prompt to serve as examples for the model to follow, and the model may then be provided the target sentence to be rewritten. The model may then infer from the examples how to rewrite the sentence. Method 300 may also include receiving one or more whitelisted words and providing the whitelisted words to the machine learning and/or generative AI models. As described above with reference to FIG. 1, whitelisted words may include one or more words and/or phrases that should not be rewritten, such as key terms in one or more subject matters to which an input document, such as the input document 102 in FIG. 1, may pertain. In some examples, whitelisted words can be received from a storage medium, such as database 103 described above with reference to FIG. 1. The machine learning and/or generative AI models may be optionally configured to ignore (e.g., not remove or replace) words and/or phrases containing words from the whitelisted word database 103, as described above with reference to FIG. 1.

Method 300 may further include step 312. Step 312 includes receiving output data including sentiment sentence rewrites from the machine learning and/or generative AI model. Thus, method 300 may enable users to generate rewrites for sentences containing one or more identified word-sentence sentiment mismatches such that the new sentence conveys a consistent sentiment while remaining factually accurate.

FIG. 4 illustrates an exemplary method for generating sentence rewrites for sentences failing readability criteria, according to some examples. Method 400 is performed, for example, using one or more electronic devices implementing a software platform. In some examples, method 400 is performed using a client-server system, and the blocks of method 400 are divided up in any manner between the server and a client device. In other examples, the blocks of method 400 are divided up between the server and multiple client devices. In method 400, some blocks are, optionally, combined; the order of some blocks is, optionally, changed; and some blocks are, optionally, omitted. In some examples, additional steps may be performed in combination with the method 400. Accordingly, the operations illustrated (and described in greater detail below) are exemplary by nature and, as such, should not be viewed as limiting.

Method 400 may be performed by a device or system component that can generating readability sentence rewrites, such as readability rewrite engine 111 described above with reference to FIG. 1. Method 400 may include step 402, wherein step 402 includes receiving sentences with readability scores that fail one or more readability criteria. Sentences with readability scores that fail one or more readability criteria may be received from a device or system component that can determine sentence readability scores, such as readability analysis engine 110 described above with reference to FIG. 1. Method 400 may include step 404, wherein step 404 includes receiving a collection of readability rewrite examples. Readability rewrite examples may be received form a storage device, such as readability rewrite example database 105 described above with reference to FIG. 1. As described above with reference to FIG. 1, readability rewrite examples received at step 404 may include before and after sentences exemplifying how a sentence may be rewritten to improve readability while maintaining the context and factual accuracy of the sentence.

Method 400 may include step 406. Step 406 includes comparing the sentences with readability scores that fail one or more readability criteria received at step 402 with the collection of readability rewrite examples received at step 404. As described with reference to FIG. 1, comparing the sentences received at step 402 with the collection of readability rewrite examples received at step 404 may include performing a lexical and/or semantic search. Method 400 may include step 408, wherein step 408 includes selecting a predetermined number of readability rewrite examples that are most similar to the sentences with readability scores that fail one or more readability criteria. As described with reference to FIG. 1, selecting a predetermined number of readability rewrite examples may include selecting the predefined number of readability rewrite examples that are most relevant and/or similar to each sentence received at step 402.

Method 400 may include step 410. Step 410 includes providing the sentences with readability scores that fail one or more readability criteria received at step 402 and the predetermined number of readability rewrite examples selected at step 408 to one or more machine learning and/or generative AI models. As described with reference to FIG. 1, one or more machine learning and/or generative AI models may be trained or otherwise configured to maintain all factual and contextual information from sentences with readability scores that fail one or more readability criteria while improving the readability score of the sentence. The machine learning and/or generative AI models may be trained or otherwise configured to follow or infer from the readability rewrite examples (e.g., provided in a prompt to the model) how to rewrite the sentences with readability scores that fail one or more readability criteria, or otherwise use the readability rewrite examples in few-shot learning. Method 400 may also include receiving one or more whitelisted words and providing the whitelisted words to the machine learning and/or generative AI models. As described above with reference to FIG. 1, whitelisted words may include one or more words and/or phrases that should not be rewritten, such as key terms in one or more subject matters to which an input document, such as the input document 102 in FIG. 1, may pertain. In some examples, whitelisted words can be received from a storage medium, such as database 103 described above with reference to FIG. 1. The machine learning and/or generative AI models may optionally be configured to ignore (e.g., not remove or replace) words and/or phrases containing words from the whitelisted word database 103, as described above with reference to FIG. 1.

Method 400 may further include step 412. Step 412 includes receiving output data including readability sentence rewrites from the machine learning and/or generative AI model. Thus, method 400 may enable users to generate rewrites for sentences with readability scores that fail one or more readability criteria such that the new sentence has improved readability for an intended audience of an input document (e.g., input document 102 in FIG. 1).

FIG. 5 illustrates an exemplary sentiment metrics output display, according to some examples. As described above with reference to FIG. 1, system 100 may display sentiment metrics generated by sentiment metrics engine 113 to a user in human readable format (e.g., tables, graphs, etc.), which may enable users to review their writing styles for future improvement. In some examples, sentiment metrics may include the number or percentage of words in an input document (e.g., input document 102 in FIG. 1) that convey sentiment, the number or percentage of words corresponding to each identified sentiment, the percentage of sentiment mismatched words per sentence, percentage of sentences with sentiment mismatched words per section of the input document, etc. In FIG. 5, output display 500 may include a table 502a with sentiment metrics such as the total number of words in the input document, the number and percentage of words that convey sentiment, the number and percentage of words that convey a negative sentiment, the number and percentage of words that convey an uncertain sentiment, and the number and percentage of words that convey a positive sentiment. Output display 500 may include a graph 502b (e.g., a pie chart) as a visual representation of the metrics in table 502a or some other sentiment metrics.

FIG. 6 illustrates an exemplary readability metrics output display, according to some examples. As described above with reference to FIG. 1, system 100 may display readability metrics generated by readability metrics engine 114 to a user in human readable format (e.g., tables, graphs, etc.), which may enable users to review their writing styles for future improvement. In some examples, readability metrics may include the average readability score of an input document (e.g., input document 102 in FIG. 1), the average readability score by section of the input document, the readability grade level of the input document, the average readability score of the input document as compared to other documents written by the organization and/or other organizations in the same field, etc. In FIG. 6, output display 600 may include a table 602 with readability metrics such as the average readability score for the input document and/or the average readability grade level for the input document. Output display 600 may include a graph 603 (e.g., a histogram) as a visual representation of the metrics in table 602 or some other sentiment metrics (e.g., the input document's readability score as compared to other documents written by other organizations in the same field).

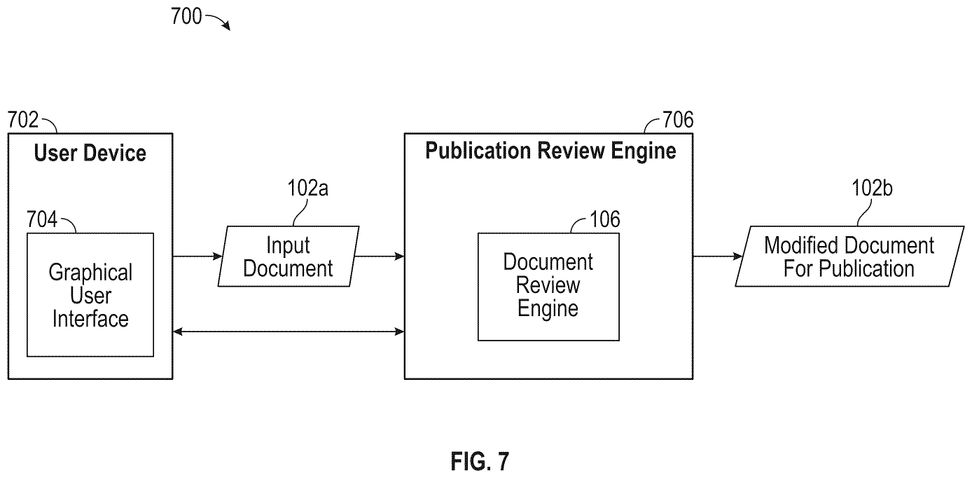

FIG. 7 shows a system 700 for reviewing and executing publication of documents, in accordance with some embodiments. System 700 may include publication review engine 706 comprising one or more processors, and publication review engine 706 may include a document review engine 106 (e.g., as described with reference to FIG. 1). Publication review engine may be communicatively coupled to electronic user device 702, which may be configured to provide a graphical user interface to a user. The user of device 702 may execute one or more inputs comprising an instruction to publish input document 102 (e.g., as described above in FIG. 1 with reference to input document 102). The instructed publication of input document 102a may comprise publication of the document to a webpage, electronic transmission of the document by email and/or file-share service, saving of the document to a database or other file store, printing of the document, and/or screen share of the document.

Publication review engine 706 may be configured to automatically intercept and block (e.g., at least temporarily halt) the instructed publication of the document, subject to application of document review for readability and sentiment criteria. After intercepting the instructed publication of the document, publication review engine may leverage document review engine 106 to analyze compliance of document 102a with one or more readability criteria, sentiment criteria, and/or other criteria, for example as described above in FIG. 1. Based on its analysis of document 102a, document review engine 106 may generate one or more proposed rewrites and/or other modifications to document 102a, for example as described above in FIG. 1.

The proposed rewrites and/or other modifications may be transmitted to user device 702 and displayed to the user via graphical user interface 704. Graphical user interface 704 may enable the user to execute one or more inputs to approve, reject, and/or modify the proposed modifications. After rejection or modification of a proposed modification, the document may be iteratively re-checked by publication review engine 706.

Once the document has been rewritten and/or otherwise modified such that all publication criteria are determined by engine 706 to be satisfied, then the modified version 102b of the document may be published, for example in the manner and via the medium originally instructed by the user.

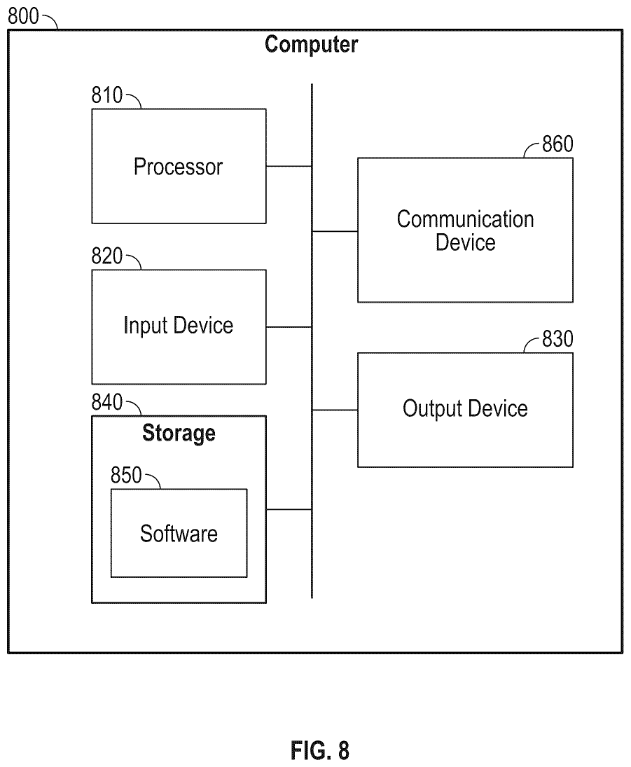

In one or more examples, the disclosed systems and methods utilize or may include a computer system. FIG. 8 illustrates an exemplary computing system according to one or more examples of the disclosure. Computer 800 can be a host computer connected to a network. Computer 800 can be a client computer or a server. As shown in FIG. 8, computer 800 can be any suitable type of microprocessor-based device, such as a personal computer, workstation, server, or handheld computing device, such as a phone or tablet. The computer can include, for example, one or more of processor 810, input device 820, output device 830, storage 840, and communication device 860. Input device 820 and output device 830 can correspond to those described above and can either be connectable or integrated with the computer.

Input device 820 can be any suitable device that provides input, such as a touch screen or monitor, keyboard, mouse, or voice-recognition device. Output device 830 can be any suitable device that provides an output, such as a touch screen, monitor, printer, disk drive, or speaker.

Storage 840 can be any suitable device that provides storage, such as an electrical, magnetic, or optical memory, including a random-access memory (RAM), cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute methods described herein.

Software 850, which can be stored in storage 840 and executed by processor 810, can include, for example, the programming that embodies the functionality of the present disclosure (e.g., as embodied in the systems, computers, servers, and/or devices as described above). In one or more examples, software 850 can include a combination of servers such as application servers and database servers.

Software 850 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for generating sentiment sentence rewrites and readability sentence rewrites for one or more sentences in an input document, the system comprising memory storing instructions and one or more processors configured to execute the instructions to cause the system to:
receive data representing the input document;
identify a plurality of sentences in the input document and a plurality of words corresponding to each of the identified plurality of sentences;
apply a sentiment mismatch data processing operation based on the identified plurality of sentences and the identified plurality of words to determine whether one or more word-sentence combinations with a sentiment mismatch are present;
apply a readability data processing operation based on the identified plurality of sentences to determine whether one or more sentences of the identified plurality of sentences fails one or more readability criteria;
in accordance with a determination that one or more word-sentence combinations with a sentiment mismatch are present and a determination that one or more sentences of the identified plurality of sentences do not fail one or more readability criteria, generate one or more first sentence rewrites for one or more sentences of the identified plurality of sentences containing the one or more word-sentence combinations with a sentiment mismatch, wherein the one or more first sentence rewrites are based on a plurality of sentiment mismatch rewrite examples;
in accordance with a determination that one or more word-sentence combinations with a sentiment mismatch are not present and a determination that one or more sentences of the identified plurality of sentences fail one or more readability criteria, generate one or more second sentence rewrites for the one or more sentences that fail one or more readability criteria, wherein the one or more second sentence rewrites are based on a plurality of readability rewrite examples;
in accordance with a determination that one or more word-sentence combinations with a sentiment mismatch are present and a determination that one or more sentences of the identified plurality of sentences do fail one or more readability criteria, generate one or more combined sentence rewrites for one or more sentences of the identified plurality of sentences containing the one or more word-sentence combinations with a sentiment mismatch and failing the one or more readability criteria, wherein the one or more combined sentence rewrites are based on the plurality of sentiment mismatch rewrite examples and the plurality of readability rewrite examples;
store one or more generated rewrites from the set comprising: the one or more generated first sentence rewrites, the one or more generated second sentence rewrites, and the one or more generated combined sentence rewrites in memory; and
generate and display a digital output document comprising one or more generated rewrites from the set comprising: the one or more generated first sentence rewrites, the one or more generated second sentence rewrites, and the one or more generated combined sentence rewrites.

2. The system of claim 1, wherein applying the sentiment mismatch data processing operation comprises:
for each sentence of the identified plurality of sentences:
determining a corresponding sentence sentiment;
for each of the identified plurality of words in the corresponding sentence, determining a corresponding word sentiment;
comparing the corresponding sentence sentiment to the corresponding word sentiments for each of the identified plurality of words in the corresponding sentence; and
determining whether the one or more word-sentence combinations with a sentiment mismatch are present.

3. The system of claim 1, wherein generating the one or more first sentence rewrites comprises:
receiving the plurality of sentiment mismatch rewrite examples;
comparing the one or more sentences of the identified plurality of sentences containing the one or more word-sentence combinations with a sentiment mismatch with the plurality of sentiment mismatch rewrite examples;
selecting, for each of the one or more sentences of the identified plurality of sentences containing the one or more word-sentence combinations with a sentiment mismatch, a predetermined number of corresponding sentiment mismatch rewrite examples from the plurality of sentiment mismatch rewrite examples;
providing the one or more sentences of the identified plurality of sentences containing the one or more word-sentence combinations with a sentiment mismatch and the selected predetermined number of corresponding sentiment mismatch rewrite examples to a machine learning model; and
receive, from the machine learning model, output data comprising the one or more first sentence rewrites.

4. The system of claim 3, wherein the selected corresponding sentiment mismatch rewrite examples are most similar to the corresponding sentence of the one or more sentences of the identified plurality of sentences containing the one or more word-sentence combinations with a sentiment mismatch.

5. The system of claim 3, wherein the corresponding sentiment mismatch rewrite examples are selected using semantic searching.

6. The system of claim 3, wherein the corresponding sentiment mismatch rewrite examples are selected by:
generating embeddings for each of the one or more sentences of the identified plurality of sentences containing the one or more word-sentence combinations with a sentiment mismatch and each of the plurality of sentiment mismatch rewrite examples; and
comparing the generated embeddings for each of the one or more sentences of the identified plurality of sentences containing the one or more word-sentence combinations with a sentiment mismatch with the generated embeddings for each of the plurality of sentiment mismatch rewrite examples.

7. The system of claim 1, wherein the one or more word-sentence combinations with a sentiment mismatch comprise only words corresponding to the sentence that are not in a predetermined word list.

8. The system of claim 1, wherein each sentiment mismatch rewrite example of the plurality of sentiment mismatch rewrite examples comprises:
an initial version of the respective sentiment mismatch rewrite example containing one or more word-sentiment mismatches; and
a rewritten version of the respective sentiment mismatch rewrite example containing fewer word-sentiment mismatches than the initial version.

9. The system of claim 1, wherein identifying the one or more word-sentence combinations with a sentiment mismatch comprises determining that one or more of the corresponding word sentiments are classified into a first classification and the corresponding sentence sentiment is not classified into the first classification.

10. The system of claim 1, wherein applying the readability data processing operation comprises:
for each sentence of the plurality of identified sentences:
determining a corresponding readability score;
comparing the corresponding readability score with the one or more readability criteria; and
determining that the corresponding readability score fails the one or more readability criteria by falling outside one or more readability criteria windows.

11. The system of claim 10, wherein determining the corresponding readability score is based on determining one or more of the following metrics: an average length of sentences in a document and a percentage of long words in a sentence or document.

12. The system of claim 1, wherein generating the one or more second sentence rewrites comprises:
receiving the plurality of readability rewrite examples;
comparing the one or more sentences that fail one or more readability criteria with the plurality of readability rewrite examples;
selecting, for each of the one or more sentences that fail one or more readability criteria, a predetermined number of corresponding readability rewrite examples from the plurality of readability rewrite examples;
providing the one or more sentences that fail one or more readability criteria and the selected predetermined number of corresponding readability rewrite examples to a machine learning model; and
receive, from the machine learning model, output data comprising the one or more second sentence rewrites.

13. The system of claim 12, wherein the corresponding readability rewrite examples are most similar to the corresponding sentence of the one or more sentences that fail one or more readability criteria.

14. The system of claim 12, wherein the corresponding readability rewrite examples are selected using semantic searching.

15. The system of claim 12, wherein the corresponding readability rewrite examples are selected by:
generating embeddings for each of the one or more sentences that fail one or more readability criteria and each of the plurality of readability rewrite examples; and
comparing the generated embeddings for each of the one or more sentences that fail one or more readability criteria with the generated embeddings for each of the plurality of readability rewrite examples.

16. The system of claim 1, wherein each readability rewrite example of the plurality of readability rewrite examples comprises:
an initial version of the respective readability rewrite example that fails at least one of the one or more readability criteria; and
a rewritten version of the respective readability rewrite example that fails fewer of the one or more readability criteria than the initial version.

17. The system of claim 1, wherein the one or more readability criteria comprises at least one of a lower readability score threshold and an upper readability score threshold.

18. The system of claim 1, wherein generating the one or more combined sentence rewrites comprises:
receiving the plurality of sentiment mismatch rewrite examples;
receiving the plurality of readability rewrite examples;
comparing the one or more sentences of the identified plurality of sentences containing the one or more word-sentence combinations with a sentiment mismatch and failing the one or more readability criteria with the plurality of sentiment mismatch rewrite examples and the plurality of readability rewrite examples;
selecting, for each of the one or more sentences of the identified plurality of sentences containing the one or more word-sentence combinations with a sentiment mismatch and failing the one or more readability criteria, a predetermined number of corresponding sentiment mismatch rewrite examples from the plurality of sentiment mismatch rewrite examples and a predetermined number of corresponding readability rewrite examples from the plurality of readability rewrite examples;
providing the one or more sentences of the identified plurality of sentences containing the one or more word-sentence combinations with a sentiment mismatch and failing the one or more readability criteria, the selected predetermined number of corresponding sentiment mismatch rewrite examples, and the selected predetermined number of corresponding readability rewrite examples to a machine learning model; and
receive, from the machine learning model, output data comprising the one or more combined sentence rewrites.

19. The system of claim 18, wherein the corresponding sentiment mismatch rewrite examples and the corresponding readability rewrite examples are most similar to the corresponding sentence of the one or more sentences of the identified plurality of sentences containing the one or more word-sentence combinations with a sentiment mismatch and failing the one or more readability criteria.

20. The system of claim 18, wherein the corresponding sentiment mismatch rewrite examples and the corresponding readability rewrite examples are selected using semantic searching.

21. The system of claim 18, wherein the corresponding sentiment mismatch rewrite examples and the corresponding readability rewrite examples are selected by:
generating embeddings for each of the one or more sentences of the identified plurality of sentences containing the one or more word-sentence combinations with a sentiment mismatch and failing the one or more readability criteria, each of the plurality of sentiment mismatch rewrite examples, and each of the readability rewrite examples; and
comparing the generated embeddings for each of the one or more sentences of the identified plurality of sentences containing the one or more word-sentence combinations with a sentiment mismatch and failing the one or more readability criteria with the generated embeddings for each of the plurality of sentiment mismatch rewrite examples and the generated embeddings for each of the readability rewrite examples.

22. The system of claim 1, wherein the digital output document comprises content from the input document and one or more generated rewrites from the set comprising: the one or more generated first sentence rewrites, the one or more generated second sentence rewrites, and the one or more generated combined sentence rewrites configured to display as interactive selectable suggestions.

23. The system of claim 1, wherein the memory storing instructions and the one or more processors configured to execute the instructions further cause the system to display one or more sentiment metrics and one or more readability metrics.

24. The system of claim 23, wherein the one or more sentiment metrics comprise the percentage of each type of word sentiment out of the identified plurality of words.

25. The system of claim 23, wherein the one or more readability metrics comprise a count of each readability score value from a plurality of readability scores corresponding to each of the identified plurality of sentences.

26. The system of claim 1, wherein:
receiving the data representing the input document comprises intercepting an instruction to publish the input document; and
the instructions further cause the system to:
in response to intercepting the instruction to publish the input document, automatically pausing publication of the input document during application of the sentiment mismatch data processing operation and the readability data processing operation;
causing display, via a graphical user interface, of the one or more generated combined sentence rewrites;
receiving, via the graphical user interface, a user input comprising an instruction to accept one or more of the combined sentence rewrites; and
after generating the digital output document comprising the one or more generated combined sentence rewrites, wherein the generating the digital output document is based on the user input comprising the instruction to accept the one or more of the combined sentence rewrites, automatically publishing the digital output document in accordance with the intercepted instruction to publish the input document.

27. A method for generating sentiment sentence rewrites and readability sentence rewrites for one or more sentences in an input document, the method performed by a system comprising memory and one or more processors, the method comprising:
receiving data representing the input document;
identifying a plurality of sentences in the input document and a plurality of words corresponding to each of the identified plurality of sentences;
applying a sentiment mismatch data processing operation based on the identified plurality of sentences and the identified plurality of words to determine that one or more word-sentence combinations with a sentiment mismatch are present;
applying a readability data processing operation based on the identified plurality of sentences to determine that one or more sentences of the identified plurality of sentences fail one or more readability criteria;
in accordance with the determination that one or more word-sentence combinations with a sentiment mismatch are present and the determination that one or more sentences of the identified plurality of sentences fail one or more readability criteria, generating one or more combined sentence rewrites for one or more sentences of the identified plurality of sentences containing the one or more word-sentence combinations with a sentiment mismatch and failing the one or more readability criteria, wherein the one or more combined sentence rewrites are based on a plurality of sentiment mismatch rewrite examples and a plurality of readability rewrite examples;
storing the one or more generated combined sentence rewrites in memory; and
generating and displaying a digital output document comprising the one or more generated combined sentence rewrites.

28. A non-transitory computer-readable storage medium storing instructions for generating sentiment sentence rewrites and readability sentence rewrites for one or more sentences in an input document, wherein, when executed by system comprising memory and one or more processors, the instructions cause the system to:
receive data representing the input document;
identify a plurality of sentences in the input document and a plurality of words corresponding to each of the identified plurality of sentences;
apply a sentiment mismatch data processing operation based on the identified plurality of sentences and the identified plurality of words to determine whether one or more word-sentence combinations with a sentiment mismatch are present;
apply a readability data processing operation based on the identified plurality of sentences to determine whether one or more sentences of the identified plurality of sentences fail one or more readability criteria;
in accordance with a determination that one or more word-sentence combinations with a sentiment mismatch are present and a determination that one or more sentences of the identified plurality of sentences do not fail one or more readability criteria, generate one or more first sentence rewrites for one or more sentences of the identified plurality of sentences containing the one or more word-sentence combinations with a sentiment mismatch, wherein the one or more first sentence rewrites are based on a plurality of sentiment mismatch rewrite examples;
in accordance with a determination that one or more word-sentence combinations with a sentiment mismatch are not present and a determination that one or more sentences of the identified plurality of sentences fail one or more readability criteria, generate one or more second sentence rewrites for the one or more sentences that fail the one or more readability criteria, wherein the one or more second sentence rewrites are based on a plurality of readability rewrite examples;
in accordance with a determination that one or more word-sentence combinations with a sentiment mismatch are present and a determination that one or more sentences of the identified plurality of sentences do fail one or more readability criteria, generate one or more combined sentence rewrites for one or more sentences of the identified plurality of sentences containing the one or more word-sentence combinations with a sentiment mismatch and failing the one or more readability criteria, wherein the one or more combined sentence rewrites are based on the plurality of sentiment mismatch rewrite examples and the plurality of readability rewrite examples;
store one or more generated rewrites from the set comprising: the one or more generated first sentence rewrites, the one or more generated second sentence rewrites, and the one or more generated combined sentence rewrites in memory; and
generate and display a digital output document comprising one or more generated rewrites from the set comprising: the one or more generated first sentence rewrites, the one or more generated second sentence rewrites, and the one or more generated combined sentence rewrites.

29. A system for generating sentiment sentence rewrites and readability sentence rewrites for one or more sentences in an input document, the system comprising memory storing instructions and one or more processors configured to execute the instructions to cause the system to:
receive data representing the input document;
identify a plurality of sentences in the input document and a plurality of words corresponding to each of the identified plurality of sentences;
apply a sentiment mismatch data processing operation based on the identified plurality of sentences and the identified plurality of words;
apply a readability data processing operation based on the identified plurality of sentences;
generate one or more combined sentence rewrites for the input document, wherein the one or more combined sentence rewrites are based on a plurality of sentiment mismatch rewrite examples and a plurality of readability rewrite examples;
store one or more generated combined sentence rewrites in memory; and
generate and display a digital output document comprising one or more generated combined sentence rewrites.

30. A method for generating sentiment sentence rewrites and readability sentence rewrites for one or more sentences in an input document, the method performed by a system comprising memory and one or more processors, the method comprising:
receiving data representing the input document;
identifying a plurality of sentences in the input document and a plurality of words corresponding to each of the identified plurality of sentences;
applying a sentiment mismatch data processing operation based on the identified plurality of sentences and the identified plurality of words;
applying a readability data processing operation based on the identified plurality of sentences;
generating one or more combined sentence rewrites for the input document, wherein the one or more combined sentence rewrites are based on a plurality of sentiment mismatch rewrite examples and a plurality of readability rewrite examples;
storing the one or more generated combined sentence rewrites in memory; and
generating and displaying a digital output document comprising the one or more generated combined sentence rewrites.

31. A non-transitory computer-readable storage medium storing instructions for generating sentiment sentence rewrites and readability sentence rewrites for one or more sentences in an input document, wherein, when executed by system comprising memory and one or more processors, the instructions cause the system to:
receive data representing the input document;
identify a plurality of sentences in the input document and a plurality of words corresponding to each of the identified plurality of sentences;
apply a sentiment mismatch data processing operation based on the identified plurality of sentences and the identified plurality of words;
apply a readability data processing operation based on the identified plurality of sentences;
generate one or more combined sentence rewrites for the input document, wherein the one or more combined sentence rewrites are based on a plurality of sentiment mismatch rewrite examples and a plurality of readability rewrite examples;
store one or more generated combined sentence rewrites in memory; and
generate and display a digital output document comprising one or more generated combined sentence rewrites.
